(19) United States
(12) Patent Application Publication
(10) Pub. No.: US 2022/0224555 A1
(43) Pub. Date: Jul. 14, 2022

(54) METHOD AND SYSTEM FOR PROVIDING TELECOMMUNICATIONS

(71) Applicant: StarLeaf Ltd, London (GB)

(72) Inventors: Nicholas Paul Aaron Johnstone, Cambridge (GB); Samuel Nathan Childs, Cambridge (GB); Nicholas Ian Moss, Middlesex (GB); Samuel Thomas Jansen, Hertfordshire (GB); Tor Klingberg, Essex (GB)

(21) Appl. No.: 17/647,218

(22) Filed: Jan. 6, 2022

(30) Foreign Application Priority Data
Jan. 8, 2021 (GB) 2100269.6

(51) Int. Cl. H04L 12/18; H04N 7/15

(52) U.S. Cl. CPC H04L 12/1827; H04L 12/1831; H04N 7/15

(57) ABSTRACT

A method for providing telecommunications on a videoconferencing system can include: a telecommunication endpoint device connecting, via the internet, to a server in a telecommunication network, the server being configured to provide a multi-tenant service; associating the telecommunication endpoint device with a tenant in the multi-tenant service; at least one peripheral device connecting to the server via the internet; associating the at least one peripheral device with the tenant; and providing telecommunications with the telecommunication endpoint device, wherein the telecommunications comprise telecommunication data and at least a portion of the telecommunication data is provided by the at least one peripheral device.

### CROSS REFERENCE TO RELATED APPLICATIONS

This application claims priority to Great Britain Application No. 2100269.6, filed on Jan. 8, 2021, the entire disclosure of which is hereby incorporated by reference.

### FIELD

The present disclosure relates to a method for providing telecommunications, in particular a method for providing telecommunications on a videoconferencing system.

### BACKGROUND

Videoconferencing meeting room endsystems are typically designed and implemented using one monolithic device which communicates either with a cloud conferencing service, or more traditionally, directly with other similar endsystems in other locations. Peripheral devices such as displays, controllers, microphones, speakerphones, and content sources, are directly connected to the endsystem using dedicated ports. This makes the endsystem relatively simple to implement because the control surface can be driven directly and the media sources are connected directly.

FIG. 1 illustrates a videoconferencing system according to the prior art. The system comprises a telecommunication endpoint device in the form of a meeting room endpoint 1, in connection with a pair of screens 2, a pair of cameras 6, a controller 3, microphones 4, and a content source 5. The connections between devices are local physical connections. The meeting room endpoint 1 connects to a cloud video service 10, via which it can communicate with another endpoint 20.

### SUMMARY

The inventors have appreciated the benefit of providing a set of individual modular endsystem components being logically associated in the cloud. Such an arrangement may provide a more convenient, simpler, and lower cost videoconferencing set up.

Arrangements of the present disclosure provide a videoconferencing system which allows a set of individual modular endsystem components to be logically associated in the cloud such that they can provide the same, or indeed improved functionality as a monolithic room system but without the associated drawbacks. Arrangements also address challenges that have prevented meeting room endsystems from being constructed in this way.

Advantageously, arrangements of the present disclosure provide that endsystem devices will not be constrained by the number of physical interfaces that they present. In addition, the wiring between devices becomes considerably simpler, and the devices themselves can be smaller and less electrically complicated.

Embodiments of the present disclosure also increase opportunity for endpoint devices to be constructed from commodity hardware which lacks specialist videoconferencing ports, but instead may only have industry standard ports such as Ethernet or universal serial bus (USB) ports.

The scope of protection is defined by the independent claims to which reference should now be made. Optional features are set forth in the dependent claims.

According to an aspect of the present disclosure, there is provided a method for providing telecommunications on a videoconferencing system, the method comprising: a telecommunication endpoint device connecting, via the internet, to a server in a telecommunication network, the server being configured to provide a multi-tenant service; associating the telecommunication endpoint device with a tenant in the multi-tenant service; at least one peripheral device connecting to the server via the internet; associating the at least one peripheral device with the tenant; and providing telecommunications with the telecommunication endpoint device, wherein the telecommunications comprise telecommunication data and at least a portion of the telecommunication data is provided by the at least one peripheral device. Such an arrangement provides for a more convenient and simpler videoconferencing system by associating the telecommunication endpoint device with one or more peripheral devices in a server via the internet, removing the need for local physical connections between devices in the videoconferencing system. The peripheral devices need not be directly connected to the endpoint (such as by direct wired connection or by direct wireless connection), but instead are connected directly to the server via the internet.

The associated telecommunication endpoint device and the associated at least one peripheral device may be grouped into a group. The group may be a collection such as a virtual collection in which a plurality of devices including a telecommunication endpoint device and one or more peripheral devices are associated. The group may be associated to a particular tenant, such that devices in a group are associated with the tenant.

The associating the telecommunication endpoint device with the tenant may comprise: the server being programmed with the identity of the telecommunication endpoint device; an identifier being entered into the telecommunication endpoint device; the telecommunication endpoint device displaying an identifier and providing the identifier to the server; and/or scanning an identifier displayed on the telecommunication endpoint device. The server may be programed with the identity of the telecommunication endpoint device during the sales process of the videoconferencing system, and the identity may include the identity of the tenant or owning organisation. The identifier may be a token associated to a user, such as a pin number or serial number. The token may have properties that make it hard to guess, but easy to read and convey, such as by typing in a number or scanning a quick response (QR) code. The identifier may be entered into the telecommunication endpoint device using a user input such as a keyboard or other input device may be connected, for example temporarily, to the telecommunication endpoint device. The telecommunication endpoint device may display, for example on a screen, an identifier such as a serial number or token. The identifier may then be provided to the server, for example via a portal such as a cloud portal to associate or claim the device and assign it to the tenant or group. Where the identifier is displayed on a screen, the identifier may be scanned for example by an application on a mobile phone, or an internet browser session to associate the telecommunication endpoint device with the tenant.

The at least one peripheral device may be any suitable electronic device. That is, the at least one peripheral device may be any device capable of functioning in the videoconferencing system including, but not limited to, cameras, displays or screens, computer devices such as laptop computers or tablet devices, controllers, content streaming devices, or the like.

The at least one peripheral device may comprise a control device configured to control at least a portion of the telecommunication data, the control device being associated with the tenant. The control device may be a controller configured to control the telecommunication endpoint device, for example to control configuration of the telecommunication endpoint device and to control a videoconference such as interaction during a videoconference of the videoconferencing system.

The method may further comprise establishing a local control channel between the control device and the telecommunication device. The local control channel may be a wired connection or a wireless connection, for example over a wireless local area network (WLAN), Bluetooth (registered trade mark), or near field communication (NFC).

The server may be a cloud server. A cloud server may be a plurality of servers geographically remote from the telecommunication endpoint device. The server may be a configuration server. The server may provide telecommunication control and media processing. The server may comprise a user input interface configured to enable configuration of the server.

The associating the control device with the tenant may comprise: the server being programmed with the identity of the control device; an identifier being entered into the control device; the control device displaying an identifier and providing the identifier to the server; and/or scanning an identifier displayed on the control device. The server may be programed with the identity of the control device during the sales process of the videoconferencing system, and the identity may include the identity of the tenant or owning organisation. The identifier may be a token associated to a user, such as a pin number or serial number. The telecommunication endpoint device may display, for example on a screen, an identifier such as a serial number or token. The identifier may then be provided to the server, for example via a portal such as a cloud portal to associate or claim the device and assign it to the tenant or group. Where the identifier is displayed on a screen, the identifier may be scanned for example by an application on a mobile phone, or an internet browser session. The telecommunication endpoint device may comprise a camera and the camera may scan the identifier on the screen or printed on the control device.

The at least one peripheral device may comprise at least one microphone and/or speaker, the at least one microphone and/or speaker being associated with the tenant. The associating the at least one microphone and/or speaker with the tenant may comprise: the server being programmed with the identity of the at least one microphone and/or speaker; an identifier being entered into the at least one microphone and/or speaker; providing an identifier displayed on the at least one microphone and/or speaker to the server; and/or scanning an identifier displayed on the at least one microphone and/or speaker. The association may be performed in a similar manner to the association of the peripheral devices and the control device set out above. Where the device is a microphone, the telecommunication endpoint device may play an association token as a sound or sequence of tones such as dual-tone multi-frequency (DTMF) tones which are detected and decoded by the microphone to establish the association between the endpoint device and the microphone.

In an arrangement in which a fixed identifier such as a printed quick response (QR) code is used, the device such as the telecommunication device or peripheral device may include a security lock mode to prevent the device being re-associated or hijacked by a different tenant or organisation until it has been de-associated with the current organisation.

It will be understood that one physical peripheral device may comprise the functionality of more than one peripheral. For instance, a controller or control device may also allow a content source to be connected, or a microphone may be part of a speakerphone.

The establishment of a logical association and logical interconnects between peripherals and telecommunication endpoint device creates a simple instance of a room system that has some similar properties to existing systems, but significantly, differs in that a network is used to form connection between devices rather than dedicated connections. In providing this, a number of opportunities for further improving the system arise.

For example, ensuring that lip-sync of video and audio is accounted for, as network connections may introduce a certain degree of latency. Video and audio that are being sampled on two separate devices may slowly drift over the source of a videoconference. In order to achieve lip-sync of video and audio, there may either be compensation for clock-drift or a mechanism for locking the clocks between the two (or more) devices. The at least one microphone and the telecommunications endpoint device may comprise clocks. The method may further comprise: locking the clock of the at least one microphone to the clock of the telecommunication endpoint device; or locking the clocks of the at least one microphone and the telecommunication endpoint device to an alternative source. The microphone may lock its clock to the clock of the endpoint using techniques including heartbeat packets. The microphone and the endpoint may lock their clocks to a public time source such as a network time protocol (NTP) clock.

The method may further comprise the telecommunication device monitoring data packets from the at least one microphone to monitor a clock rate of the at least one microphone and compensating for drift in the clock rate by dropping or inserting sample data packets.

The method may comprise using acoustic echo-cancellation. Acoustic echo-cancellation typically requires very low latency connections between microphones, speakers, and the echo-canceller. An algorithm may be implemented to achieve the acoustic echo-cancellation. The algorithm may require the input from the one or more microphones and the output of the one or more speakers, the purpose being to analyse the sound picked up from the loudspeakers by the microphones such that it can be subtracted from the overall sound picked up by the microphones, thus leaving the local sound sources. In order to achieve this most effectively, the algorithm may use clock synchronisation between the microphones and the speakers so that the timings are precise and consistent when comparing the input and output streams. This becomes more difficult when the microphones and speakers are using different clocks, as in devices logically associated over a network, rather than having dedicated physical connections. The synchronisation of clocks may be performed as set out above, but for efficient acoustic echo-cancellation, the tolerance of synchronisation is more constrained. If compensation is performed, then fractional resampling may be required to avoid step-changes in the audio propagation timings determined by the echo-cancelling algorithm. Echo-cancellation may be performed at the microphone, or at the telecommunication endpoint device. If it is performed at the microphone, then a stream from the endpoint device to the microphone may be used to provide the audio samples being sent to the speakers. Advantageously, this is scalable to multiple microphones without extra processing power being required in the endpoint.

In the case of a local meeting, that is where meeting participants may be located at the same geographical location, it may be desirable that content be sent directly between a content source and an endpoint device, rather than via a cloud server. This advantageously allows much higher bandwidth and latency to be available for showing content in a meeting without using any wide area network (WAN) bandwidth. If that local content is then shared with a remote meeting participant, an endsystem may transcode the content stream, for instance to a lower frame rate, before transmission to the cloud. If there are multiple active content sources, then, if peer-to-peer connections are in place, then only the currently shared source need be sent over the WAN to the remote participant.

Where the cloud service is geographically remote to the telecommunication endpoint device, it may be desirable to alleviate latency between the endpoint device and the cloud server to ensure a responsive user interface. For example, if the cloud service is on the other side of the world from the meeting room, then the latency may be 300 ms or more. This level of latency is long enough that a user interface may have slow responsiveness and potentially feel sluggish. For this reason, it may be beneficial for a local control path to be established between each of the control surfaces and the endpoint. This allows user-interface commands that should have immediate visible effects to be actioned without significant or noticeable latency.

In some arrangements, peer-to-peer connections between peripheral devices and the telecommunication endpoint devices may be established over a local connection such as a wireless local area network connection. The connection to the common cloud service may enable the peripheral devices to easily discover both the local and public network addresses of one another and of the telecommunication endpoint device. A connection technique may be used which may compensate for difficulties such as subnet traversal or network address translation (NAT). Once such a local connection is in place, the connection may enable control and media traffic to travel between the telecommunication endpoint device and the peripherals with much lower latency than without. This latency is low enough such that potential negative effects as discussed above can be mitigated.

The at least one peripheral device may comprise a content source, the content source being associated with the tenant. The associating the content with the tenant may comprise: the server being programmed with the identity of the content source; an identifier being entered into the content source; providing an identifier displayed on or by the content source to the server; connecting an auxiliary device to the content source and entering an identifier into the auxiliary device; and/or scanning an identifier displayed on or by the content source. The association may be as set out above in relation to the association of the peripheral devices, control devices, microphones, or speakers.

The content source or content provider device may be any suitable electronic device, such as a computer device, for example a laptop computer device or tablet device. Alternatively, the content source or content provider device may connect to an electronic device, and the content may be provided to the telecommunication endpoint device via the content source.

The method may further comprise establishing a local communication channel between the content source and the telecommunication endpoint device, the local communication channel being configured to allow transmission of content between the content source and the telecommunication endpoint device.

The method may further comprise transcoding content shared locally between the content source and the telecommunication server and transmitting the transcoded content via the server.

The method may further comprise establishing a local connection between the at least one peripheral device and the telecommunication endpoint device. The local connection may be a peer-to-peer connection over a local area network.

The telecommunications data may comprise one or more of: media data comprising audio and/or visual content; and control data. Audio and visual data may be data sent by, or received by, a telecommunication endpoint device, which may originate from one or more peripheral devices or a remote endpoint device. Control data may comprise data configured to control at least a portion of the videoconference, for example any input which may affect the videoconference including calling, sharing of media content, graphical user interface configuration, or the like.

In some embodiments, a plurality of telecommunication endpoint devices may be grouped together. That is, a second telecommunication device may connect, via the internet, to the server in the telecommunication network and be associated with the same tenant in the multi-tenant service as the telecommunication device. Any amount of telecommunication endpoint devices may be connected in this way. Each of the plurality of telecommunication endpoint devices may have associated with it, one or more peripheral devices. The plurality of telecommunication endpoint devices may be located in the same physical location, such as located in a single meeting room. This is beneficial as multiple endpoints in the same meeting room may be conveniently grouped in the cloud server.

According to another aspect of the disclosure, there is provided a computer program for performing the method as described above.

There is also provided a videoconferencing system for implementing the method described above.

According to another aspect of the disclosure, there is provided a videoconferencing system for providing telecommunications, the videoconferencing system comprising: a telecommunication endpoint device configured to connect with a server in a telecommunication network via the internet, the server being configured to provide a multi-tenant service and the telecommunication device endpoint device being configured to be associated with a tenant in the multi-tenant service; at least one peripheral device configured to: connect to the server via the internet; and be associated with the tenant; wherein: the videoconferencing system is configured to provide telecommunications with the telecommunications endpoint device; and the telecommunications comprise telecommunication data and the at least one peripheral device is configured to provide at least a portion of the telecommunication data.

The telecommunication endpoint device and the at least one peripheral device are configured to be grouped into a group.

The telecommunication endpoint device may be configured to be associated with the tenant by: the server being configured to be programmed with the identity of the telecommunication endpoint device; the telecommunication endpoint device being configured to receive an entry comprising an identifier; the telecommunication endpoint device being configured to display an identifier and provide an identifier to the server; and/or the telecommunication endpoint device being configured to display an identifier to be scanned.

The at least one peripheral device may comprise a control device configured to control at least a portion of the telecommunication data, the control device being configured to be associated with the tenant. The control device and the telecommunication endpoint device may be configured to establish a local control channel between the two devices.

The control device may be configured to be associated with the tenant by: the server being configured to be programmed with the identity of the control device; the control device being configured to receive an entry comprising an identifier; the control device being configured to display an identifier and provide the identifier to the server; and/or the control device being configured to display an identifier to be scanned.

The at least one peripheral device may comprise at least one microphone and/or speaker, the at least one microphone and/or speaker being configured to be associated with the tenant. The at least one microphone and/or speaker may be configured to be associated with the tenant by: the server being configured to be programmed with the identity of the at least one microphone and/or speaker; the at least one microphone and/or speaker being configured to receive an entry comprising an identifier; the at least one microphone and/or speaker being configured to display an identifier and provide the identifier to the server; and/or the at least one microphone and/or speaker being configured to display an identifier to be scanned.

The at least one microphone and/or speaker may comprise at least one microphone and the at least one microphone and the telecommunication endpoint device comprise clocks, the clock of the at least one microphone being configured to be locked to the clock of the telecommunication endpoint device, or the clocks of the at least one microphone and the telecommunication endpoint device being configured to be locked to an alternate time source.

The telecommunication endpoint device may be configured to monitor data packets from the at least one microphone to monitor a clock rate of the at least one microphone and compensating for drift in the clock rate by dropping or inserting sample data packets. The at least one microphone and/or speaker may comprise at least one microphone and at least one speaker.

The videoconferencing system may be configured to provide acoustic echo-cancellation. The acoustic echo-cancellation may comprise using an algorithm configured to analyse sound picked up by the at least one microphone and remove sound picked up by the at least one microphone and is output by the at least one speaker. The microphone may be configured to perform the acoustic echo-cancellation.

The at least one peripheral device may comprise a content source being configured to be associated with the tenant. The content source may be configured to be associated with the tenant by: the server being configured to be programmed with the identity of the control device; the control device being configured to receive an entry comprising an identifier; the control device being configured to display an identifier and provide the identifier to the server; an auxiliary device being configured to be connected to the content source and receive an entry comprising an identifier; and/or the control device being configured to display an identifier to be scanned.

A local control channel may be configured to be established between the content source and the telecommunication endpoint device, the local communication channel being configured to allow transmission of content between the content source and the telecommunication endpoint device. The telecommunication endpoint device may be configured to transcode content shared locally between the content source and the telecommunication endpoint device and transmit the transcoded content via the server.

The at least one peripheral device and the telecommunication endpoint device may be configured to establish a local control channel between the two devices. The local control channel may be a peer-to-peer connection over a local area network.

The telecommunications data may comprise one or more of: media data comprising audio and/or visual content; and control data.

In some embodiments, the videoconferencing system further comprises a second telecommunication endpoint device configured to connect with the server in the telecommunication network via the internet and being configured to be associated with the tenant in the multi-tenant service. The videoconferencing system may comprise any number of telecommunication endpoint devices, each of which may be configured to be associated with the same tenant. That is, all of the telecommunication endpoint devices may be conveniently grouped. Each of the telecommunication endpoint devices may have at least one peripheral device associated with it.

### BRIEF DESCRIPTION OF THE DRAWINGS

The disclosure will now be described in more detail, by way of example, with reference to the accompanying drawings, in which:

FIG. 1 is a schematic diagram of a videoconferencing system according to the prior art;

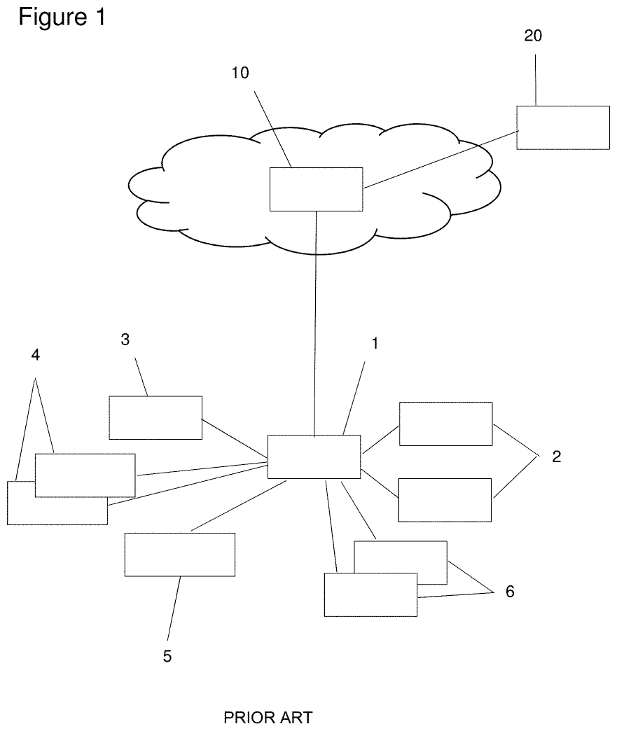

FIG. 2 is a schematic diagram of a videoconferencing system embodying an aspect of the present disclosure; and

FIG. 3 is a schematic diagram of a videoconferencing system embodying an aspect of the present disclosure.

Like features are denoted by like reference numerals.

### DETAILED DESCRIPTION

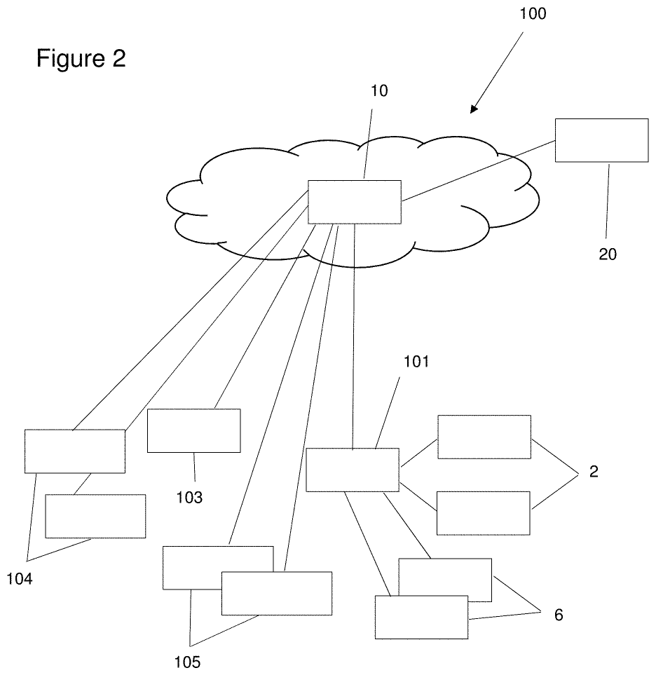

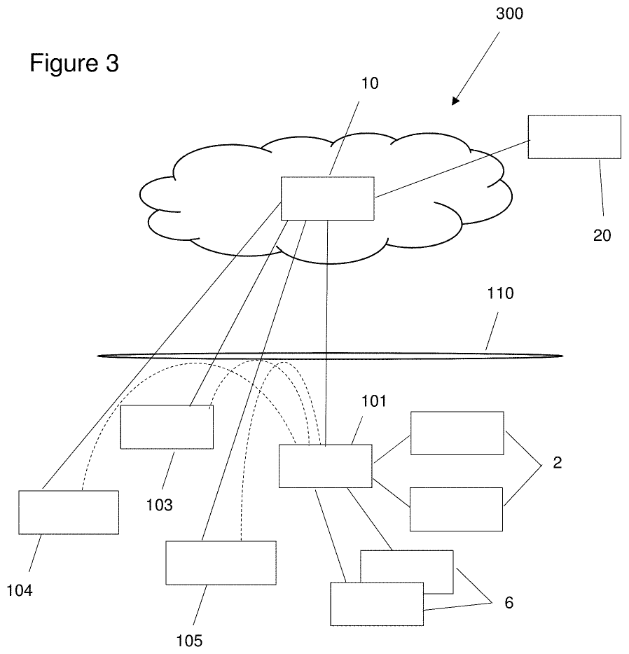

An example videoconferencing system will now be described with reference to FIGS. 2 and 3.

FIG. 2 illustrates a videoconferencing system 100. The videoconferencing system 100 comprises a modular endsystem. The videoconferencing system 100 comprises a telecommunication endpoint device which in this example is a meeting room endpoint 101. The meeting room endpoint 101 is in connection with a server via the internet. In this example the server is a cloud service 10. The cloud service 10 provides a multi-tenant service, and the meeting room endpoint 101 is configured to be associated with a tenant in the multi-tenant service. In this example, each tenant in the multi-tenant service corresponds to an organisation.

The system 100 also comprises at least one peripheral device. In this example, the peripheral devices include displays 2, cameras 6, microphones 104, and content sources 105. Significantly, the peripheral devices are connected to the cloud service 10 via the internet, and are not connected directly to the endpoint 101. The peripheral devices are also associated with the tenant. The meeting room endpoint 101 and the peripheral devices are grouped into a group by the cloud service 10. That is, the meeting room endpoint 101 and the peripheral devices are logically associated in the cloud server such that they are able to communicate with one another via the internet and provide telecommunication data for telecommunications, rather than requiring dedicated local physical connections.

The various devices are associated with the tenant through the cloud service 10. The cloud service 10 provides a registration/association service for devices via a user configuration interface in the form of a web interface. The web interface is accessible via the meeting room endpoint 101. In this example, the devices are associated with the tenant by a user inputting identifiers of each device into the web interface for the cloud server 10 which are either displayed on the devices themselves, or are displayed on one of the screens 2. The identifiers in this example are QR codes. Once the devices are associated with the tenant, the devices are “locked” to the tenant to prevent re-association, until the devices are un-associated with said tenant.

The videoconferencing system 100 is configured to provide telecommunications with the meeting room endpoint 101. The telecommunications comprise telecommunication data, and the peripheral devices provide at least a portion of the telecommunication data. The telecommunication data in this example comprises audio and visual data, and control data.

The controller 103 controls at least some of the telecommunication data. That is, the controller 103 enables a user to control the videoconference, for example by selecting and making calls, sharing media content, or controlling any other aspect of a videoconference.

The videoconferencing system 100 provides telecommunications between meeting room endpoint 101, and a remote endpoint device 20. The remote endpoint device 20 is also connected with the cloud service 10 via the internet, and in this example is associated with a different tenant in the multi-tenant service.

The meeting room endpoint 101 and the microphones 104 comprise clocks. The clocks of the meeting room endpoint device 101 and the microphones 104 are locked to one another using heartbeat packets. This avoids drift of video and audio being sampled on separate devices and ensures lip-sync of video and audio.

A videoconference may be established between meeting room endpoint 101 and remote endpoint device 20. Devices in connection with meeting room endpoint 101 are connected to one another via the cloud service 10, and are logically associated in the cloud service 10 to form a virtual meeting room. The videoconference is performed seamlessly, without the need for dedicated physical connections between locally grouped devices.

FIG. 3 illustrates a videoconferencing system 300. The system 300 is similar to that illustrated in FIG. 2. However, FIG. 3 differs in that the videoconferencing system 300 comprises local, peer-to-peer connections between peripheral devices and the meeting room endpoint 101. These local control channels are in the form of direct media optimisation paths formed over, in this example, a local corporate network 110.

For example, a local control channel is formed between the control device 103 and the meeting room endpoint 101. A local control channel is also formed between the content sources 105 and the meeting room endpoint 101. These control channels provide for the transmission of content between the content sources 105 and the meeting room endpoint 101. To form these local connections, the cloud service 10, to which all of the devices are connected, enables discovery of the local and public network addresses of one another, thereby facilitating connection between the devices. In this example, subnet traversal is used to form local connections. These local connections provide low latency between local devices, whilst the devices are still connected to the cloud service 10 and are logically associated in the cloud, thereby retaining the benefits of such an arrangement as described above.

During a videoconference, for example between meeting room endpoint 101 and remote endpoint device 20, content sent between the two endpoint devices may be transmitted and received as in the arrangement of FIG. 2 described above. However, content or communications which are only required locally to meeting room endpoint 101 may be sent and received via the peer-to-peer connections, rather than being passed via the cloud service 10. This advantageously provides for optimum latency in all communications in the videoconferencing system.

Embodiments of the present disclosure have been described. It will be appreciated that variations and modifications may be made to the described embodiments within the scope of the present disclosure.

1. A method for providing telecommunications on a videoconferencing system, the method comprising:
connecting a telecommunication endpoint device, via the internet, to a server in a telecommunication network, the server being configured to provide a multi-tenant service;
associating the telecommunication endpoint device with a tenant in the multi-tenant service;
connecting at least one peripheral device to the server via the internet;
associating the at least one peripheral device with the tenant; and
providing telecommunications with the telecommunication endpoint device, wherein
the telecommunications comprise telecommunication data and at least a portion of the telecommunication data is provided by the at least one peripheral device.

2. A method for providing telecommunications according to claim 1 wherein the associated telecommunication endpoint device and the associated at least one peripheral device are grouped into a group.

3. A method for providing telecommunications according to claim 1 wherein the associating the telecommunication endpoint device with the tenant comprises: programming the server with the identity of the telecommunication endpoint device; entering an identifier into the telecommunication endpoint device; displaying by the telecommunication endpoint device an identifier and providing the identifier to the server; and/or scanning an identifier displayed on the telecommunication endpoint device.

4. A method for providing telecommunications according to claim 1 wherein the at least one peripheral device comprises a control device configured to control at least a portion of the telecommunications data, the control device being associated with the tenant.

5. A method for providing telecommunications according to claim 4 further comprising establishing a local control channel between the control device and the telecommunication endpoint device.

6. A method for providing telecommunications according to claim 4 wherein the associating the control device with the tenant comprises: programming the server with the identity of the control device; entering an identifier into the control device; displaying by the control device an identifier and providing the identifier to the server; and/or scanning an identifier displayed on the control device.

7. A method for providing telecommunications according to claim 1 wherein the at least one peripheral device comprises at least one microphone and/or speaker, the at least one microphone and/or speaker being associated with the tenant.

8. A method for providing telecommunications according to claim 7 wherein the associating the at least one microphone and/or speaker with the tenant comprises: programming the server with the identity of the at least one microphone and/or speaker; entering an identifier into the at least one microphone and/or speaker; displaying by the at least one microphone and/or speaker an identifier and providing the identifier to the server; and/or scanning an identifier displayed on the at least one microphone and/or speaker.

9. A method for providing telecommunications according to claim 7 wherein the at least one microphone and/or speaker comprises at least one microphone and the at least one microphone and the telecommunication endpoint device comprise clocks, the method further comprising: locking the clock of the at least one microphone to the clock of the telecommunication endpoint device; or locking the clocks of the at least one microphone and the telecommunication endpoint device to an alternate time source.

10. A method for providing telecommunications according to claim 7, the method further comprising monitoring, by the telecommunication endpoint device, data packets from the at least one microphone to monitor a clock rate of the at least one microphone and compensating for drift in the clock rate by dropping or inserting sample data packets.

11. A method for providing telecommunications according to claim 7 wherein the at least one microphone and/or speaker comprises at least one microphone and at least one speaker.

12. A method for providing telecommunications according to claim 11 further comprising using acoustic echo-cancellation.

13. A method for providing telecommunications according to claim 12 wherein the acoustic echo-cancellation comprises using an algorithm configured to analyse sound picked up by the at least one microphone and remove sound picked up by the at least one microphone which is output by the at least one speaker.

14. A method for providing telecommunications according to claim 13 wherein the acoustic echo-cancellation is performed by the at least one microphone.

15. A method for providing telecommunications according to claim 1 wherein the at least one peripheral device comprises a content source, the content source being associated with the tenant.

16. A method for providing telecommunications according to claim 15 wherein the associating the content source with the tenant comprises: programming the server with the identity of the content source; entering an identifier into the content source; displaying by the content source an identifier and providing the identifier to the server; connecting an auxiliary device to the content source and entering an identifier into the auxiliary device; and/or scanning an identifier displayed on or by the content source.

17. A method for providing telecommunications according to claim 15 further comprising establishing a local communication channel between the content source and the telecommunication endpoint device, the local communication channel being configured to allow transmission of content between the content source and the telecommunication endpoint device.

18. A method for providing telecommunications according to claim 17 further comprising transcoding content shared locally between the content source and the telecommunication endpoint device and transmitting the transcoded content via the server.

19. A method for providing telecommunications according to claim 1 further comprising establishing a local connection between the at least one peripheral device and the telecommunication endpoint device.

20-29. (canceled)

30. A videoconferencing system for providing telecommunications, the videoconferencing system comprising:
a telecommunication endpoint device configured to connect with a server in a telecommunication network via the internet, the server being configured to provide a multi-tenant service and the telecommunication endpoint device being configured to be associated with a tenant in the multi-tenant service; and
at least one peripheral device configured to: connect to the server via the internet; and be associated with the tenant;
wherein: the videoconferencing system is configured to provide telecommunications with the telecommunications endpoint device; and the telecommunications comprise telecommunication data and the at least one peripheral device is configured to provide at least a portion of the telecommunication data.

31-49. (canceled)
